(19) United States
(12) Patent Application Publication
(10) Pub. No.: US 2025/0022699 A1
(43) Pub. Date: Jan. 16, 2025

(54) A METHOD OF CONFIGURING A STRING OF PULSES

(71) Applicant: Waters Technologies Ireland Limited, Dublin (IE)

(72) Inventor: Richard Denny, Wilmslow (GB)

(73) Assignee: Waters Technologies Ireland Limited, Dublin (IE)

(21) Appl. No.: 18/711,470

(22) PCT Filed: Nov. 18, 2022
(86) PCT No.: PCT/GB2022/052934

§ 371 Date: May 17, 2024

(30) Foreign Application Priority Data
Nov. 19, 2021 (GB) 2116737.4

(51) Int. Cl. H01J 49/00; H01J 49/40

(52) U.S. Cl. CPC H01J 49/0036; H01J 49/40

(57) ABSTRACT

A method of configuring a string of pulses for an encoded frequent pulsing (EFP) acquisition, comprising: (a) generating a string containing N pulses, each pulse occurring at a respective time tₙ, the string of length T, wherein in use the string of pulses is repeated to create a stream of pulses; (b) calculating the respective span intervals Δtₙ^{(k)} between each pulse and every other pulse in the string, wherein k is the number of pulses in the span interval Δtₙ^{(k)} (k being between 1 and N); (c) determining the degree of overlap D of the calculated span intervals Δtₙ by calculating the relative difference δΔt therebetween; (d) calculating the degree of uniformity S of the string of pulses; (e) calculating an objective function F=S−D for the string of pulses; (f) reconfiguring the string to alter the time tₙ of at least one pulse in the string; (g) calculating the objective function F′ for the reconfigured string and, if F′ is higher than F, adopting the reconfigured string.

### FIELD

The present invention relates generally to time of flight (ToF) mass spectrometry in which ions are pulsed into a ToF mass analyser at a relatively high rate, using Encoded Frequent Pulsing (EFP), resulting in a multiplexed ion signal. More specifically, the present invention relates to optimising a string of pulses used in an EFP acquisition, endeavouring to increase the quality of the demultiplexed data.

### BACKGROUND

Traditional ToF mass analysers have flight paths that lead to separation timescales of the order of around 20 ms to 200 ms for mass ranges up to a few thousand Dalton.

However, more recently, ToF mass analysers which have relatively longer flight paths have been developed enabling ions to be analysed with a relatively high mass resolution, such as multi-reflecting ToF mass analysers.

Historically, typical ToF mass analysers have been operated according to a ‘pulse-and-wait’ operating scheme wherein a mass spectrum (denoting the intensity and time of flight of detected ions) is recorded for all of the ions within a pulse before the next packet of ions is pulsed, such that ions from different pulses do not temporally overlap. Such arrangements inherently have a low duty cycle.

To increase duty cycle, especially for ToF mass analysers having relatively longer flight paths, techniques have been developed in which ions are pulsed into the ToF mass analyser at a relatively higher rate, such that ions from different pulses are caused to temporally overlap, resulting in multiplexed spectral data containing ion signals from different pulses. The resulting spectral data must then be decoded (i.e. demultiplexed) in order to obtain a meaningful mass spectrum for the sample.

To facilitate this it is known to operate the ToF mass analyser according to a so-called Encoded Frequency Pulsing (EFP) scheme wherein ions are pulsed into the ToF mass analyser multiple times per transient.

The mass spectral data can then be decoded (demultiplexed) based on knowledge of the pulsing scheme. However, the use of EFP may serve to reduce the accuracy of the decoding, potentially leading to the loss of useful data.

It is believed there is scope for improved methods for multiplexing and subsequently decoding mass spectral data obtained using such EFP schemes. The present disclosure seeks to provide an improved method of configuring a string of pulses for an encoded frequent pulsing (EFP) acquisition.

### BRIEF DESCRIPTION OF THE INVENTION

Accordingly, the present invention provides a method of configuring a string of pulses for an encoded frequent pulsing (EFP) acquisition, comprising:
(a) generating a string containing N pulses, each pulse occurring at a respective time tₙ, the string of length T, wherein in use the string of pulses is repeated to create a stream of pulses;
(b) calculating the respective span intervals Δtₙ^{(k)} between each pulse and every other pulse in the string, wherein k is the number of pulses in the span interval Δtₙ^{(k)} (k being between 1 and N);
(c) determining the degree of overlap D of the calculated span intervals Δtₙ by calculating the relative difference δΔt therebetween;
(d) calculating the degree of uniformity S of the string of pulses;
(e) calculating an objective function F=S−D for the string of pulses;
(f) reconfiguring the string to alter the time tₙ of at least one pulse in the string;
(g) calculating the objective function F′ for the reconfigured string and, if F′ is higher than F, adopting the reconfigured string.

In at least one embodiment, the time intervals Δtₙ between adjacent pulses in the generated string are unique.

In at least one embodiment, the step of generating a string of N pulses comprises generating an initial string of N pulses in which the intervals are progressively increasing or decreasing along the string.

In at least one embodiment, the step of generating a string of N pulses further comprises subsequently reordering the initial string so that the intervals are not progressively increasing or decreasing along the string.

In at least one embodiment, the method further comprises calculating the complement span intervals of T−Δtₙ^{(k)}, and wherein determining the degree of overlap D includes calculating the relative difference δΔt of the calculated span intervals Δtₙ and the complement span intervals of T−Δtₙ (k).

In at least one embodiment, the degree of overlap D is expressed as

$$D = {\sum }_{Δ t = 0}^{T - 1} {w}_{Δ t} max ( 0 , {d}_{Δ t} - 1 ) .$$

In at least one embodiment, the objective function F′ for the reconfigured string is the same or lower than the objective function F for the previous string, rejecting the reconfigured string and retaining the previous string.

In at least one embodiment, the method further comprises iteratively repeating steps (b) to (g) for each pulse in the string.

In at least one embodiment, the method further comprises iteratively repeating steps (f) and (g) for the same pulse in the string, until a predetermined termination event.

In at least one embodiment, the predetermined termination event is that the time tₙ of the given pulse has been altered, and the objective function F′ recalculated, a predetermined number of times.

In at least one embodiment, the step of reconfiguring the string comprises altering the time tₙ of the at least one pulse such that the span interval between the at least one pulse and the previous pulse in the string, and the span interval between the at least one pulse and the next pulse in the string is at least a predetermined minimum.

In at least one embodiment, there is provided a method of performing an encoded frequent pulsing (EFP) acquisition, comprising:
configuring a sequence of pulses according to the invention;
pulsing ions through an analyser;
detecting a plurality of ion strikes on a detector;
generating a spectrum of the detected ion strikes; and
demultiplexing the spectrum using the sequence of pulses.

In at least one embodiment, the method comprises disregarding a predetermined portion of the spectrum coincident with a pulse in the string.

In at least one embodiment, there is provided a computer readable storage medium storing software code that when executing on a data processor performs a method according to the invention.

### BRIEF DESCRIPTION OF THE FIGURES

In order that the present disclosure may be more readily understood, embodiments thereof will now be described, by way of example only, with reference to the accompanying drawings, in which:

FIG. 1 schematically illustrates a string of pulses;

FIG. 2 schematically illustrates a stream of pulses which comprises a repeated pattern of the string of pulses of FIG. 1;

FIG. 3 schematically illustrates a stream of pulses and the respective span intervals;

FIG. 4 illustrates the transmission profile of a first string; and

FIG. 5 illustrates the transmission profile of a second string.

### DETAILED DESCRIPTION OF THE DISCLOSURE

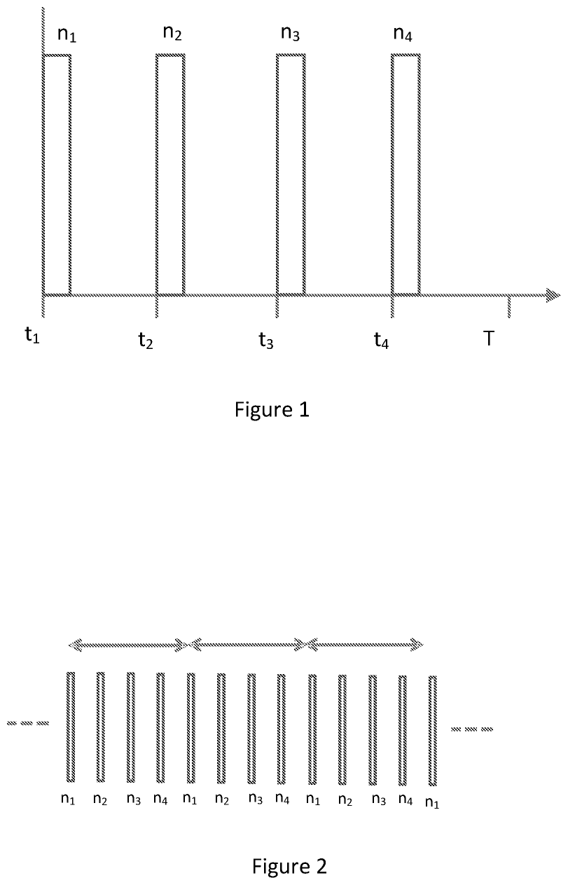

FIG. 1 schematically illustrates a string of pulses. In the string illustrated, there are 4 pulses, n₁-n₄, each occurring at time t₁-t₄. A pulse may otherwise be referred to as a ‘push’. The string of pulses causes ions to be pulsed multiple times per transient such that, in use, the transient contains overlapping ion peaks from different ion pulses. The first data set may thus represent a set of multiplexed ion arrival times for ions recorded in one or more transient(s). A “transient” is the time over which a single encoded mass spectrum (covering the entire mass to charge range of interest, from low to high) is accumulated and the duration of a transient thus generally corresponds to the flight time for the highest mass-to-charge ratio ion within the mass range that is being recorded. A transient thus serves as a convenient time measure for breaking up the data that may reflect both the pulse pattern and the longest flight time of interest.

The length of the string of pulses is configured to be of substantially the same length as a transient. With reference to FIG. 1, the length (in time) of the string of pulses is denoted herein as T.

In the string illustrated in FIG. 1, the first pulse n₁ occurs at the beginning of the string, at t₁. In the example shown, t₁ equals zero. There are then 3 subsequent pulses, n₂-n₄, in the string. After the fourth pulse, n₄, a period of time passes before the end of the string (transient).

In use, the string of pulses is repeated to create a stream of pulses, as schematically illustrated in FIG. 2. The string of pulses repeats multiple times, and may be far longer than schematically illustrated in FIG. 2. For example, for a transient of 2 ms length, when used with a chromatography run of 40 minutes, the string of pulses may be repeated over a million times in a stream (e.g. 1200000 times) for an acquisition.

An inherent consequence of using EFP, with its multiplexed spectral data containing ion signals from different pulses, is that some overlaps are likely to occur between peaks of various ion species. The overlaps could therefore be systemic, depending on the time intervals between pulses.

It has previously been observed, for example by the applicant in US2013/00488520 and by LECO Corporation in US2013/0048852 and US2017/0084443, that if the intervals between pulses are made unique (i.e. unequal), the systemic overlaps may be reduced.

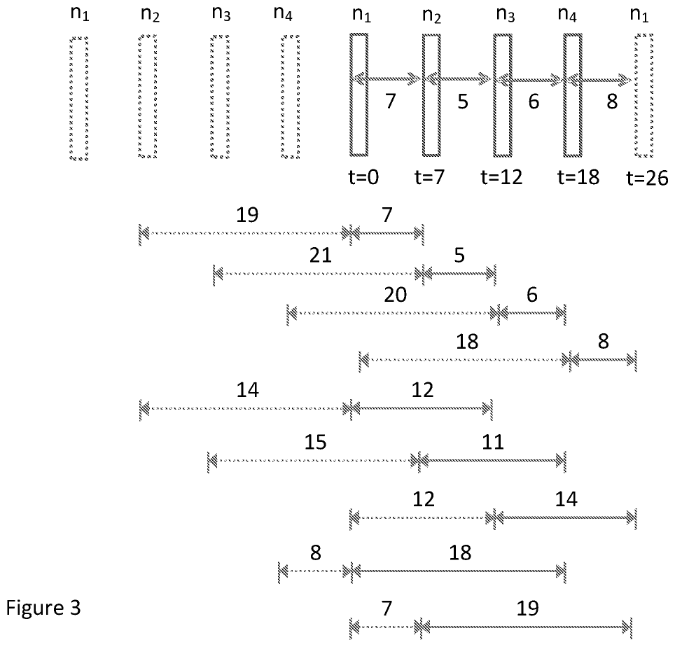

As schematically illustrated in FIG. 3, in a string comprising 4 pulses (n=4), there are intervals between each of the pulses in a string, ie from n₁→n₂, n₂→n₃ and n₃→n₄. The lengths of the intervals are expressed as t₂-t₁, t₃-t₂ and t₄-t₃. Since the string of pulses is repeated, there is also an interval between n₄ of the current string and n₁ of the next string. This is equal to T-t₄ (when n₁ occurs at the beginning of the transient and therefore t₁ is coincident with the beginning of the transient). These are the intervals between neighbouring pulses.

We may also consider intervals which span k pulses. The intervals noted above are for k=1.

When k=2, the intervals are between n₁→n₃, n₂→n₄. The lengths of the intervals are expressed as t₃−t₁ and t₄−t₂. There is also the interval between n₃ of the current string and n₁ of the next string, the length of which may be expressed as T−t₃.

When k=3, there is an interval between n₁→n₄, expressed as t₄−t₁. There is also an interval between n₂ of the current string and n₁ of the next string, the length of which may be expressed as T−t₂.

Finally, when k=4, the only interval is between n₁ of the current string and n₁ of the next string. This is inherently equal to the transient length, T.

For every span interval Δtₙ^{(k)} between a first selected pulse in a string and a second selected pulse later in the string (a forward interval), there is a corresponding complement span interval between the first selected pulse in the current string and the second selected given pulse in the previous string (a backward interval). Since the transient length is T, the complement span interval can be expressed as T−Δtₙ^{(k)}.

For a string comprising N pulses, there are a total of

$$\frac{N ( N - 1 )}{2}$$

forward intervals and a total of

$$\frac{N ( N - 1 )}{2}$$

backward intervals.

To reduce excessive overlap, it is desirable that the relative difference Δtₙ^{(k)} between any two pulses should be distinct from the relative difference Δtₙ^{(k)} between any two other pulses. This reduces the chances of peaks systemically overlapping. The greater the relative difference, the less the chance of overlaps.

To make a qualitative assessment of the extent to which the respective span intervals might differ, the degree of overlap may be calculated.

It is observed that it is unavoidable that two pulse times will cause times of flight to overlap where the difference in time of flight is equal to the difference in the pulse times. It may not be known in advance of the acquisition what times of flight will occur and so increment a counter at a time of flight difference equal to the difference in pulse times to count the coincidences that may occur using the entire string of pulses. In accumulating the excess number of coincidences across the range of time of flight differences, a weighting scheme may be adopted.

When the difference between two intervals is calculated, a weighting factor may be applied which is proportional to the difference between the two intervals. For example, a higher weighting may be applied when the difference is small, and a lower weighting applied when the difference is greater. The weighting value applied may be inversely proportional to the difference between two intervals. The weighting scheme may be non-linear.

Next, the degree of uniformity of the transmission of the string of pulses is calculated. This is the entropy of the transmission of the possible times of flight in use.

In use, when spectral data is obtained using a string of pulses, an artefact of the pulse is present in the spectral data. The artefact effectively obliterates the useful data in that region-so-called “pusher pickup”. A pulse may comprise a square wave—as schematically illustrated in FIG. 1—and so the effects of pusher pickup may be experienced following both the leading edge and trailing edge.

It is beneficial if the artefacts of the pulses in the spectrum can be identified and those regions in the spectrum ignored for further processing.

Since the character of each pulse is known, it is possible to calculate the effect of pusher pickup. The pulse width may be defined as W. The width of the region following the pulse edge (leading or trailing edge) which is affected by pusher pickup may be defined as B. The value of B may be predetermined. Accordingly, the region in the spectrum which may be affected by pusher pickup is defined as.

$$ℬ = {⋃}_{n = 0}^{N - 1} [ {t}_{n} , {t}_{n} + B ] ⋃ [ {t}_{n} + W , {t}_{n} + W + B ]$$

The expression [tₙ, tₙ+B] defines the period/region of time after the leading edge of the pulse, and the expression [tₙ+W, tₙ+W+B] defines the period/region of time after the trailing edge of the pulse. It will be appreciated that the distance between the start of each of the two noted regions is W, which is equal to the pulse width W.

Although in the example above the value of B is the same for both the leading and trailing edge, it may differ. For example, a value of B₁ may be applied to the leading edge, and a value of B₂ may be applied to the trailing edge. B₁ may be smaller or larger than B₂.

Accordingly, the revised region in the spectrum which may be affected by pusher pickup may be defined as:

$$ℬ = {⋃}_{n = 0}^{N - 1} [ {t}_{n} , {t}_{n} + {B}_{1} ] ⋃ [ {t}_{n} + W , {t}_{n} + W + {B}_{2} ]$$

These regions (two regions, each of width B or B₁/B₂) are flagged before processing spectral data to prevent or reduce the promulgation of spurious signals. Effectively, they define a mask to be applied to the spectral data.

We may define the transmission of a signal at time of flight, sϵ[0, T−1], as,

$$𝒯 ( s ) = N - {\sum }_{n = 0}^{N - 1} {1}_{ℬ} ( {t}_{n} + s ) ,$$

where 1_{B}(t) is the indicator function for tϵB and the result of the addition tₙ+S is computed modulo T.

Next, the degree of uniformity of the transmission of the string of pulses is calculated. We can assign the transmission profile, across the range of possible flight times, an entropy,

$$= {\sum }_{s = 0}^{T - 1} {w}_{s} [ 𝒯 ( s ) - N - 𝒯 ( s ) ln ( 𝒯 ( s ) / N ) ] ,$$

which maximises at zero for perfect transmission, and where wₛ is a weighting function.

This, effectively, provides a qualitative assessment of the anticipated quality of transmission using a string of pulses.

Next, an objective function of F=S−D is calculated. F will nominally maximise for an optimal string of pulses (i.e. maximum transmission with no overlap).

A string of pulses with the highest possible value of F will therefore be the most optimal in terms of minimising the effects of pusher pickup and overlapping data.

An objective of the claimed invention is to explore whether the value of F can be maximised, or at least usefully increased.

Accordingly, after calculating F for a given string of pulses, the time tₙ of at least one pulse in the string is altered, and F′ is recalculated for the reconfigured string. If F′ is higher than F for the previous string, then the reconfigured string is adopted for further processing.

Conversely, if F′ is higher than F for the previous string, then the reconfigured string is not adopted for further processing, and the existing string is retained for further processing.

In at least one embodiment, the step of altering the time tₙ comprises altering the time tₙ within the range of tₙ₋₁ and tₙ₊₁. In at least one embodiment, altering the time tₙ comprises ensuring that the interval between the altered time tₙ and tₙ₋₁ and the interval between the altered time tₙ and tₙ₊₁ is at least a predetermined minimum (a distance constraint). This is to avoid the intervals in that region of the reconfigured string being so small as to introduce or increase any systemic overlaps.

In at least one embodiment, for a given pulse, the steps of altering the time tₙ, and recalculating F are repeated (iterated) a predetermined number of times, for example 3, in an attempt to optimise the value of F. The altered times of tₙ may be randomly sampled (selected) within the region bounded by the constraints.

In at least one embodiment, the steps of altering the time tₙ of at least one pulse in the string is performed for more than one pulse in the string. In at least one embodiment, the steps of altering the time tₙ of at least one pulse in the string is performed on all of the pulses in the string either sequentially or randomly.

For a given initial stream of pulses, a method embodying the claimed invention seeks to optimise the stream of pulses by systematically altering the timings of the individual pulses, seeking incremental increases in F. When a reconfigured string leads to a higher value of F, it is adopted for further processing. When F of a reconfigured string is lower than that of the previous string, the reconfigured string is discarded, and the previous string is kept for further processing.

In one embodiment, an initial string of pulses having unique time intervals between pushes may be constructed using a quadratic function, forming a string of pulses with progressively increasing intervals between the pulses If there are N pulses in a transient, the n^{th} push occurs at:

$${t}_{n} = n {Δ}_{1} + n ( n + 1 ) {Δ}_{2} , \qquad n ∈ [ 0 , N - 1 ] ,$$

where Δ₁ and Δ₂ are increments (constants) which can be adjusted so that N pushes are accommodated in the transient of length T and that overlaps and obliterations are reduced.

An interval between consecutive pushes is given by:

$$Δ {t}_{n} = {t}_{n + 1} - {t}_{n} = {Δ}_{1} + 2 ( n + 1 ) {Δ}_{2} .$$

This sequence of first differences form a regular comb starting from Δt₀=Δ₁+2Δ₂ and ending at Δt_{N-2}=Δ₁+2(N−1)Δ₂, spaced out by 2Δ₂.

Two signals with times of flight s₁ and s₂ where s₂−s₁=Δtₙ will overlap at arrival time, tₙ+s₂=tₙ₊₁+s₁. We wish to avoid another Δt_{n′} causing a coincident overlap with time of flight, s₃.

More generally, an interval which spans k pushes is given by:

$$Δ {t}_{n}^{( k )} = {t}_{n + k} - {t}_{n} = k ( {Δ}_{1} + ( 2 n + k + 1 ) {Δ}_{2} ) .$$

For a quadratic function, n+k<N.

It is desired that each value of Δtₙ^{(k)} must be distinct from any Δt_{n′}^{=(k)}, if we assume Δ₁>>Δ₂. This is the case as n appears in the expression for Δtₙ^{(k)} with non-zero coefficient (and power). In addition, each interval should be distinct from any boundary crossing complement, T−−t_{n″}^{(N-k)} where n″<k. Therefore, we require,

$$Δ {t}_{n}^{( k )} + Δ {c}_{{n}^{″}}^{( N - k )} \neq T .$$

The constraint may be further improved by applying an exclusion zone to account for finite peak width, so that,

$$Δ {t}_{n}^{( k )} + Δ {t}_{{n}^{″}}^{( N - k )} ∉ [ T - ΔT , T + Δ T ] .$$

In at least one embodiment, the step of generating a string of N pulses comprises generating an initial string of N pulses in which the intervals are progressively increasing or decreasing along the string, for example using a quadratic function as described above.

In at least one embodiment, the initial string is reordered, so that the intervals are not progressively increasing or decreasing along the string. The reordering may be random. The reording may include predetermined constraints. For example, the string may be reordered such that, in the reordered string, each pulse is not adjacent to a pulse to which it was previously adjacent in the initial string. This is to avoid a sub-string of pulses which are progressively increasing or decreasing.

With reference to FIG. 3, a string of pulses is schematically shown. In this example, there are 4 pulses, having the following times: [t₁=0, t₂=7, t₃=12, t₄=18]. The transient length T is 26.

As noted in FIG. 3, the intervals are 7, 5, 6 and 8. Accordingly, all the intervals are unique. For simplicity, the pulses are illustrated as being spaced equally in FIG. 3.

FIG. 3 illustrates the span intervals, and their complement, as follows:

| | Span interval | Complement span |
|---|---|---|
| Interval | length (Δtₙ^{(k)}) | interval (T-(Δtₙ^{(k)}) |
| n₁-n₂ | 7 | 19 |
| n₂-n₃ | 5 | 21 |
| n₃-n4 | 6 | 20 |
| n₄-n′₁ | 8 | 18 |
| n₁-n₃ | 12 | 14 |
| n₂-n₄ | 11 | 15 |
| n₃-n′₁ | 14 | 12 |
| n₁-n₄ | 18 | 8 |
| n₂-n′₁ | 19 | 7 |

The degree of overlap D is determined by calculating the relative difference δΔt between the calculated span intervals.

In one embodiment, an absolute comparison between each of the intervals and span intervals is made. In the example illustrated above, there are two instances of an interval of 7, two of 8, two of 12, two of 14, two of 18, two of 19.

In summary, over a total number of 18 intervals, there are 6 pairs of intervals of the same size.

It is desired to minimise differences δΔt between pulse intervals Δt that are at or close to zero, i.e., any δΔtϵ[−ΔT, +ΔT] are penalized, wherein ΔT describes an anticipated peak half-width. As explained above, each “forward” interval, Δt, has a complementary “backward” interval, T−Δt, where T is the transient length.

For example, with N=20 pushes there are

$$\frac{N ( N - 1 )}{2} = 190$$

forward intervals and the same number of backward intervals, giving a total of 380 intervals.

Each interval can be accumulated onto a grid of length T, each interval described by Δt±ΔT. As single overlaps are unavoidable, one cell from each grid cell is subtracted where it contains a value greater than zero.

By increasing ΔT, intervals are made to “repel” more strongly during the optimisation stage.

This is illustrated in the grid below, where each of the intervals is denoted with a bar that extends by one time unit either side (ΔT=1). Accordingly, the interval of 7 is shown extending across time units 6 to 8 (i.e. 7±1).

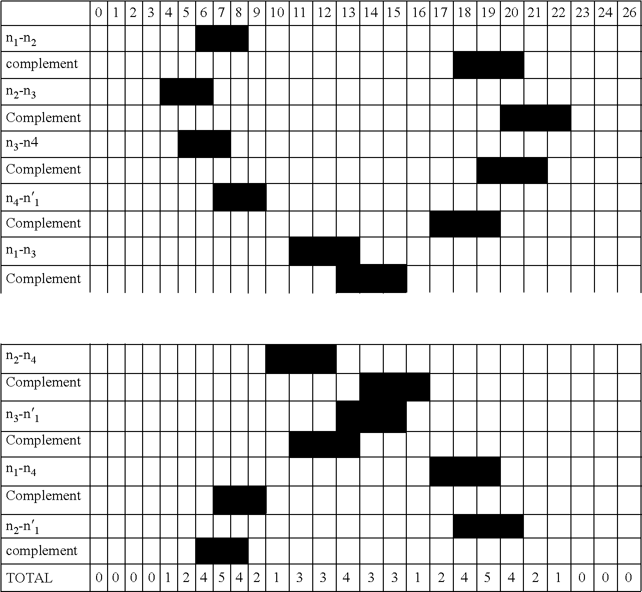

At the bottom of the grid, a tally is taken of all the intervals (including the tolerance) which are coincident with each time unit.

The tally for the example above is 55. However, A single overlap between two intervals is unavoidable, so each non-zero tally for a each time value is adjusted to subtract 1, leading to a cumulative total of 34.

This tally (as adjusted), provides a qualitative assessment of the relative differences between intervals for a given string. It will be appreciated that if the interval values are evenly spaced across the transient length, the number of overlaps will reduce, leading to a greater relative difference.

The degree of overlap for a given string may therefore be expressed as:

$$D = {\sum }_{Δ t = 0}^{T - 1} {w}_{Δ t} max ( 0 , {d}_{Δ t} - 1 ) .$$

w_{Δt} is a weighting function for each element of flight time difference.

The degree of uniformity S (entropy) of the string of pulses is then calculated, before calculating an objective function F=S−D for the string of pulses.

Next, the string is reconfigured to alter the time tₙ of at least one pulse n in the string. The pulse to be reconfigured may be chosen at random.

Suppose that pulse n₃ is chosen. Pulse n₃ is at time 12, and is adjacent pulse n₂ at time 7 and pulse n₄ at time 18. The respective intervals are 5 and 6.

According to a method embodying the claimed invention, the time of pulse n₃ may be altered. The times of the adjacent pulses n₂ and n₄ are not adjusted. Therefore, the altered time of n₃ cannot be less than the time (7) of pulse n₂ and cannot be greater than the time (18) of pulse n₄. The altered time of pulse n₃ must fall in the range of 7-18.

According to at least one embodiment, the step of reconfiguring the string comprises altering the time tₙ of the at least one pulse such that the span interval between the at least one pulse and the previous pulse in the string, and the span interval between the at least one pulse and the next pulse in the string is at least a predetermined minimum.

In the present example, the predetermined minimum may be 3. Accordingly, the altered time of the pulse n₃ must fall in the range between 10 (i.e. 7+3) and 15 (i.e. 18-3).

The altered time of pulse n₃ may be randomly decided, so long as it meets the above constraint.

Suppose that the time of pulse n₃ is altered to 13. As a consequence, the length of the intervals between pulse n₃ and other pulses in the reconfigured string are now different than for the initial string.

The degree of overlap D, degree of uniformity S and thus the objective function F are recalculated for the reconfigured string.

If the objective function F′ for the reconfigured string is higher than the objective function F for the previous string, it can be taken that the reconfigured string represents an improvement on the previous string. The reconfigured string can then be adopted for further processing.

In at least one embodiment, the time of same pulse n₃ is further altered, and the objective function F recalculated, to ascertain whether a higher objective function can be obtained. The time of the pulse n₃ may be altered until a predetermined termination event, such as having been altered a predetermined number of times, for example 3. The predetermined termination event may instead be that the objective function F has increased by a predetermined percentage from a previous or initial value.

According to at least one embodiment, the method further comprises iteratively altering the time of every pulse in the string, or at least a predetermined number of pulses, recalculating the objective function F each time to ascertain whether a higher value is achieved.

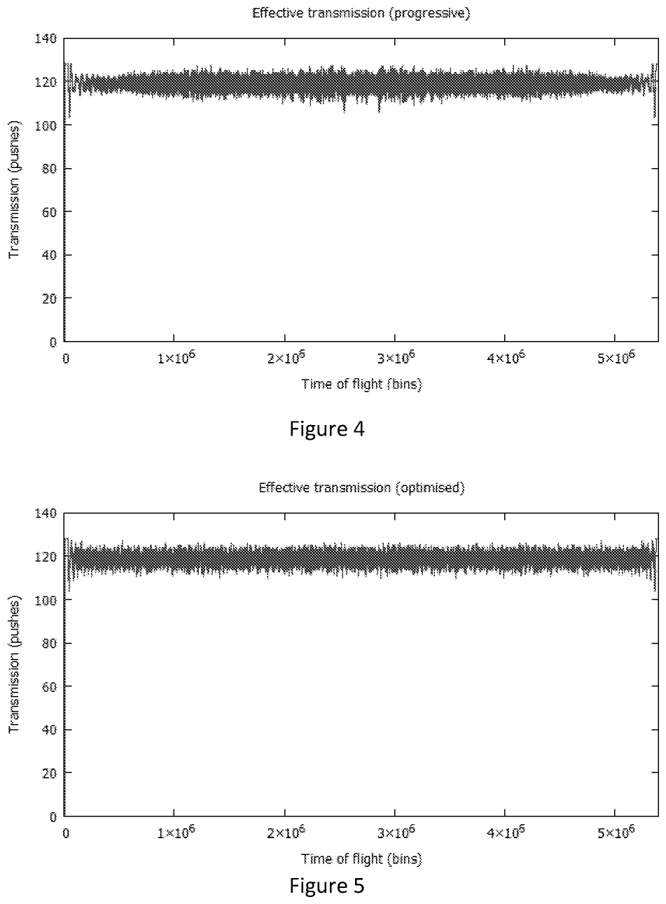

FIG. 4 illustrates the transmission profile of a string based on a quadratic function having pulses occurring at

$${t}_{n} = n {Δ}_{1} + n ( n + 1 ) {Δ}_{2} , \qquad n ∈ [ 0 , N - 1 ] ,$$

In this example, Δ₁=32768, Δ₂=128 and W=7800, B=1500. The entropy of this profile is S=−2.311×10⁶ and the degree of overlap is D=49784 (Δt=14) with F=S−D=−2360294.

According to at least one embodiment, the order of a string based on a quadratic function is first reordered so that the intervals are not progressively increasing or decreasing along the string. The reordering may be substantially random.

FIG. 5 illustrates the transmission of the string of FIG. 4 having been optimised according to the claimed invention. The entropy of this profile is S=−2.296×[10]\hat{ }6 and the degree of overlap is D=15008 with F=S−D=−2311078.

It will therefore be noted that the objective function F for the optimised string of FIG. 5 is higher than that of FIG. 4.

According to one embodiment of the present invention, there is provided a method of performing an encoded frequent pulsing (EFP) acquisition, comprising: configuring a sequence of pulses according to the invention;
pulsing ions through an analyser;
detecting a plurality of ion strikes on a detector;
generating a spectrum of the detected ion strikes; and
demultiplexing the spectrum using the sequence of pulses.

Also provided is a mass spectrometer for performing such methods. The mass spectrometer may thus comprise a ToF mass analyser, optionally an ion separation device upstream of the ToF mass analyser, and suitable decoding circuitry that is configured for decoding the data obtained from the ToF mass analyser. The decoding circuitry may thus be configured to decode a first data set representing a set of multiplexed ion arrival times recorded using the ToF mass analyser to determine a second data set, the second data set representing one or more demultiplexed mass spectra relating to the flight times for the ions that were pulsed into the ToF mass analyser to generate the first data set. The decoding circuitry may be configured to decode such data using the sequence of pulses.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A method of configuring a string of pulses for an encoded frequent pulsing (EFP) acquisition, comprising:
(a) generating a string containing N pulses, each pulse occurring at a respective time tₙ, the string of length T, wherein in use the string of pulses is repeated to create a stream of pulses;
(b) calculating the respective span intervals Δtₙ^{(k)} between each pulse and every other pulse in the string, wherein k is the number of pulses in the span interval Δtₙ^{(k)} (k being between 1 and N);
(c) determining the degree of overlap D of the calculated span intervals Δtₙ by calculating the relative difference δΔt therebetween;
(d) calculating the degree of uniformity S of the string of pulses;
(e) calculating an objective function F=S−D for the string of pulses;
(f) reconfiguring the string to alter the time tₙ of at least one pulse in the string;
(g) calculating the objective function F′ for the reconfigured string and, if F′ is higher than F, adopting the reconfigured string.

2. A method according to claim 1, wherein the time intervals Δtₙ between adjacent pulses in the generated string are unique.

3. A method according to claim 1, wherein the step of generating a string of N pulses comprises generating an initial string of N pulses in which the intervals are progressively increasing or decreasing along the string.

4. A method according to claim 3, wherein the step of generating a string of N pulses further comprises subsequently reordering the initial string so that the intervals are not progressively increasing or decreasing along the string.

5. A method according to claim 1, further comprising calculating the complement span intervals of T−Δtₙ^{(k)}, and wherein determining the degree of overlap D includes calculating the relative difference δΔt of the calculated span intervals Δtₙ and the complement span intervals of T−Δtₙ^{(k)}.

6. A method according to claim 1, wherein the degree of overlap D is expressed as
$$D = {\sum }_{Δ t = 0}^{T - 1} {w}_{Δ t} max ( 0 , {d}_{Δ t} - 1 ) .$$

7. A method according to claim 1, wherein if the objective function F′ for the reconfigured string is the same or lower than the objective function F for the previous string, rejecting the reconfigured string and retaining the previous string.

8. A method according to claim 7, further comprising iteratively repeating steps (b) to (g) for each pulse in the string.

9. A method according to claim 7, further comprising iteratively repeating steps (f) and (g) for the same pulse in the string, until a predetermined termination event.

10. A method according to claim 9, wherein the predetermined termination event is that the time tₙ of the given pulse has been altered, and the objective function F′ recalculated, a predetermined number of times.

11. A method according to claim 1, wherein the step of reconfiguring the string comprises altering the time tₙ of the at least one pulse such that the span interval between the at least one pulse and the previous pulse in the string, and the span interval between the at least one pulse and the next pulse in the string is at least a predetermined minimum.

12. A method of performing an encoded frequent pulsing (EFP) acquisition, comprising:
configuring a sequence of pulses according to any preceding claim;
pulsing ions through an analyser;
detecting a plurality of ion strikes on a detector;
generating a spectrum of the detected ion strikes; and
demultiplexing the spectrum using the sequence of pulses.

13. A method according to claim 1412, comprising:
disregarding a predetermined portion of the spectrum coincident with a pulse in the string.

14. A computer readable storage medium storing software code that when executing on a data processor performs a method according to claim 1.
